(19) United States
(12) Patent Application Publication
(10) Pub. No.: US 2022/0202025 A1
(43) Pub. Date: Jun. 30, 2022

(54) NEW BLADE FOR A SCREW CONVEYOR

(71) Applicant: Lambhusasund EHF., Akranes (IS)

(72) Inventor: Ingolfur ARNASON, Akranes (IS)

(21) Appl. No.: 17/599,865

(22) PCT Filed: Mar. 30, 2020
(86) PCT No.: PCT/IS2020/050012

§ 371 Date: Sep. 29, 2021

(30) Foreign Application Priority Data
Mar. 29, 2019 (IS) 050261

(51) Int. Cl. A22C 7/00; A22C 25/08; A23B 4/06; B65G 33/30

(52) U.S. Cl. CPC A22C 7/0092; A22C 25/08; A22B 5/0076; B65G 33/30; A23B 4/062

(57) ABSTRACT

The invention provides a device and a method for conveying and treating food items in liquid in a tank. The device is designed for transferring and treating food items in liquid simultaneously, such as cooling, thawing or treating the food items with additives. The blade of the invention is a dual action blade as it both advances the food items along the container as well as creating repeated forward and backwards pushing of the items as the blade is rotated.

### FIELD OF THE INVENTION

The invention provides a method and a device for transferring and treating food items. Furthermore, the present invention provides a new type of blade for a screw conveying device used in treating food items such as fish.

### BACKGROUND

A continuous development of food processing, such as fish products is always on demand and a big effort has been put into increasing utilization and value of the product as well as meeting demands for quality after processing.

An array of devices has been developed for cooling and treating food items or thawing food items such as fish after storage and before processing. Screw conveyor tanks have been used for both purposes, where the food items are advanced along a tank in liquid for either thawing up frozen fish or cooling freshly caught fish.

WO 2014/174535 discloses a method for processing undercooled fish, chilled by super-chilling using a saline solution and slurry ice to bring the fish to an undercooled state and processing the fish after being brought to an undercooled state. This technology has the drawback that the temperature of the slurry is at the freezing point of the slurry solution determined by the salt concentration and the temperature of the surface and the inside of the fish will not be the same. Furthermore, the temperature of the slurry solution being at its freezing point will result in the surface of the fish to freeze and/or create form an ice shell.

One of the problems of handling and processing fresh fish is bacterial contaminations such as listeria contamination. One of the processes to reduce or eliminate bacterial contamination in fish is freezing, but freezing is not always desirable and especially when providing fresh unfrozen fish to fish markets.

EP 2 328 420 discloses an apparatus for thawing or cooling food products comprising a tank filled with heating or cooling medium and a spiral shaped blade or screw conveyor extending between opposite ends of the tank. The blade rotates and provides a rotational movement of the screw conveyor thereby conveying the food products between opposite ends of the tank. A temperature controlling system regulates the temperature of the heating or cooling medium. The tank is designed to have a plurality of heat or cooling supplying units along the tank to provide a substantial uniform temperature distribution into the liquid during the thawing or cooling of the food products.

### SUMMARY OF THE INVENTION

The present invention provides a device and a method for conveying/transferring and treating food items in liquid in a tank. The device is designed for transferring and treating food items in liquid simultaneously, such as cooling, thawing or treating the food items with additives, where the blade advances a certain amount of food in liquid in each pitch of the screw blade. The blade of the invention is a dual action blade as it both advances the food items along the container as well as creating repeated forward and backwards pushing of the items as the blade is rotated. This is accomplished by a special blade design. The blade is a spiral shaped blade divided into sectors by alternating forward and backward radial bends along the length of the spiral blade alternately changing the angle of the spiral blade along each sector. A forward radial bend, being forward in the advancing direction of the blade, leaves the following sector being bent in the negative advancing direction and thereby creating a backwards push of the material resting against that sector, whereas a backward radial bend, being backwards in the advancing direction of the blade, leaves the following sector being bent in the positive advancing direction and thereby creating a forward advancement of the material resting against that sector. A forward direction of a sector of the blade allows the blade to move the items in liquid in the advancing direction of the tank, whereas a backwards direction of a sector of the blade pushes the items in liquid backwards in the pitch. The repeated forward and backwards movement of the items being transferred by the blade creates a tumbling movement of the items which are being advanced in the container and allows them to interact better with the liquid and the temperature in the tank. If the tank is being used to thaw food items, such as frozen fish, the tumbling helps itemizing clumps of frozen fish. The device of the present invention can be connected to a heat exchange element for continuously passing temperature controlled liquid through the container via the fluid inlets and outlets in the container. As the liquid is being pumped out of the container and through a heat exchanger, the fluid can be passed through a filtering device to filter the liquid before it is pumped back into the container/tank.

Each 360° of the blade can be divided into a set number of sectors by the radial bends and the size of each individual sector can also vary based on the desired treatment. For example, the blade can be divided into 16 sectors, where each forward moving sector of 35° is followed by a backwards moving sector of 10°, such that a whole circle of the blade would comprise eight repetitions of alternating 35° and 10° sectors. The 35° sector will focus on advancement of the material and the 10° sector would facilitate a small back push, which would be beneficial to stir the liquid in the container but would not tumble the material much. However, if the forward moving sector is 25° and the backwards moving sector is 20°, then there is much more of a relative tumbling or displacement of the material in the container, which would be beneficial for mechanically treat the food items during the transfer for example for increasing tenderness of meat.

It is an object of the present invention to overcome or ameliorate the aforementioned drawbacks of the prior art and to provide an improved and/or alternative and/or additional method or device for transferring and treating food items in liquid. It is one preferred object of the present invention to provide a screw conveyor device with a spiral shaped blade for advancing and treating food items at the same time.

Moreover, it is a preferred object of the present invention to provide a device and method, preferably designed as an elongated cooling tank with a cylindrical or semi-cylindrical bottom portion, where the spiral shaped blade has a diameter corresponding to the inner circumference of the container and wherein the spiral blade has alternating positive and negative radial bends along the length of the spiral blade, thereby alternately changing the direction of the spiral blade with respect to its advancing direction, such that the food items are pushed backwards and forwards depending on the direction of the blade. Another preferred object of the present invention is to provide a spiral blade for screw conveyors having alternating positive and negative radial bends along the length of the spiral blade to provide mechanical treatment of food as it is conveyed in the conveyor to give food, such as meat, more tenderness. Also, it is one preferred object of the present invention to provide a device and a method where the design of the spiral blade and the size of the sectors created by the positive and negative radial bends determines how hard or soft the treatment of the food items is.

The advantage of the apparatus and the method of the present invention is that the device can facilitate treatment of food items as they are transferred or incubated in the device. The spiral shaped blade forms a space between each two adjacent blades of the spiral, so that a certain amount of food can be fed in a space at the in-feed end of the device and evacuated at the out-feed end for batching purposes. The alternating positive and negative radial bends along the length of the spiral blade provide tumbling effect of the food at the bottom of the container, such that the when it is being treated by the liquid in the tank, it will both get treatment effect from the liquid and the mechanical treatment form the blade.

The object(s) underlying the present invention is (are) particularly solved by the features defined in the independent claims. The dependent claims relate to preferred embodiments of the present invention. Further additional and/or alternative aspects are discussed below.

Thus, at least one of the preferred object of the present invention is solved by an apparatus for transferring and treating food items in liquid. The apparatus comprises a container, a spiral shaped blade mounted to a rotation axis for advancing the food items from one end of the container to the other and one or more fluid inlets and one or more fluid outlets for feeding liquid in and out of the container. Furthermore, the spiral blade has alternating positive or forward and negative or backward radial bends along the length of the spiral blade for alternately changing the angle of the spiral blade.

Another preferred object of the present invention is solved by method for transferring and treating food items in liquid, the method comprising the steps of; a) transferring the food items to a container with a spiral shaped blade mounted to a rotation axis for advancing the food items from one end of the container to the other, said container further comprising one or more fluid inlets and one or more fluid outlets for feeding liquid in and out of the container, b) advancing the food items from the in-feed end to the out-feed end of the container, and c) transferring the items out of the container. The spiral blade has alternating positive and negative radial bends along the length of the spiral blade, thereby alternately changing the direction of the spiral blade with respect to its advancing direction, such that the food items are pushed backwards and forwards depending on the direction of the blade.

A further object of the present invention is solved by method for transferring and treating food items in liquid, the method comprising using the apparatus of the present invention.

### DESCRIPTION OF THE INVENTION

The following definitions and embodiments relate to the method and the apparatus of the invention.

In the present context the terms “positive radial bend” or “forward radial bend” relate to a bend in the spiral shaped blade where the pointing direction of the angle caused by the bend is in the forward moving direction of the blade, i.e. in the direction of which the objects are transferred using the spiral shaped blade.

In the present context the terms “negative radial bend” or “backwards radial bend” relate to a bend in the spiral shaped blade where the pointing direction of the angle caused by the bend is in the backwards moving direction of the blade, i.e. in the opposite direction of which the objects are transferred using the spiral shaped blade.

In the present context the term “sector” refers to the surface of the blade between every positive and negative radial bend in the blade. For definition purposes each sector is defined as being a portion of a 360° rotation of the screw blade. Therefore, when a 360° rotation of the blade is divided into 8 functional units of 45° between two positive or negative radial bends, each functional unit has two sectors where one is directed in the negative advancing direction of the blade, thereby creating a backwards push of the material resting against that sector and the other sector is directed in the positive advancing direction of the blade and thereby creating a forward advancement of the material resting against that sector. The size of the two sectors of the 45° functional unit of the blade may be of the same or different size where a large sector directed in the negative advancing direction of the blade pushes the items far back and creates a harder treatment of the items compared to a smaller sector directed in the negative advancing direction of the blade pushes the gently back and creates a softer treatment of the items in the conveyor.

In the present context the term “under-cooling” or “sub-chilling” refers to the process or method of bringing fish to a desired temperature at or near the phase transition of freezing the fish without freezing the fish, and generally below the freezing point of water (0° C.). Furthermore, these terms refer to a fish or fish product being brought to or kept at a desired temperature at or near the phase transition of freezing the fish without freezing the fish, such as a temperature below 0° C. (sub-zero conditions), such as preferably at or below −0.2° C., or more preferably at or below −0.5° C., or at or below −0.7° C., or at or below −0.8° C., such as at or below −1.0° C., such as at or below −1.5° C.

In the present context the term “food items” refers to whole slaughtered animals, such as, but not limited to fish or chicken, or processed or severed parts of slaughtered animals, such as, but not limited to fish fillet, liver, chicken breast etc.

In the present context the term “fish” or “whole fish” relates to a fish which is either freshly caught and unprocessed at all or cut and/or bled and/or gutted and/or washed and/or graded and/or de-headed and/or the tail has been removed or any combination thereof.

In the present context the terms “rigor”, “rigor phase” and “rigor mortis” refer to stiffening of muscles after death or slaughtering of fish. The terms are equally used for what is accomplished by the present invention, which is delaying the fish for entering rigor mortis and also keeping the fish in the rigor phase for a longer time per time unit. The term “delaying rigor mortis” in slaughtered fish” refers to both delaying the fish for entering rigor mortis and prolonging the time the fish takes to pass through the rigor phase.

In an embodiment of the present invention the alternating positive and negative radial bends along the length of the spiral blade divide the blade into sectors.

In an embodiment of the present invention the sector behind a positive bend is of the same size or of a different size as the sector behind negative bend.

In an embodiment of the present invention the size of a sector is defined as part of a 360° circle of the spiral shaped blade.

In an embodiment of the present invention the sector behind a positive bend is directed in the negative advancing direction of the blade and wherein sector behind negative bend is directed in the positive advancing direction of the blade.

In an embodiment of the present invention the container is an elongated tank with a cylindrical or semi-cylindrical bottom portion, where the spiral shaped blade has a diameter corresponding to the inner circumference of the container.

In an embodiment of the present invention the spiral shaped blade further comprises openings for the liquid to pass through.

In an embodiment of the present invention the tank is connected to a heat exchange element for continuously passing temperature controlled liquid through the container via the fluid inlets and outlets in the container.

In an embodiment of the present invention the, the apparatus further comprises a filtering device to filter the liquid before it is passed through the heat exchanger.

In an embodiment of the present invention the, the apparatus further comprises a plurality of inlets along the length of the container to inject fluid under the items in the container to further affect or treat the food items in the container.

In an embodiment of the present invention the, the apparatus further comprises a temperature feedback control unit, to set the temperature of a liquid in the container

In an embodiment of the present invention the degree of the forward and backward bend in the blade can vary.

In an embodiment of the present invention the size of the sectors between each forward and backward bend in the blade can vary.

In an embodiment of the present invention the speed of rotation of the spiral shaped blade can vary in one 360° rotation of the blade depending on the position of the direction of the sectors of the blade in the container.

In an embodiment of the present invention the alternating positive and negative radial bends along the length of the spiral blade, thereby alternately changing the direction of the spiral blade with respect to its advancing direction, divide the blade into sectors, where the sector behind a positive bend is of the same size or of a different size as the sector behind negative bend, and wherein the size of the alternately changing sectors determines the treatment of the food items.

In an embodiment of the present invention the sector behind a positive bend is directed in the negative advancing direction of the blade and thereby creating a backwards push of the material resting against that sector, and wherein sector behind negative bend is directed in the positive advancing direction of the blade and thereby creating a forward advancement of the material resting against that sector.

In an embodiment of the present invention the apparatus is used for thawing up food items.

In an embodiment of the present invention the device is a designed to marinate food items such as portioned meat or fish.

In an embodiment of the present invention the apparatus is used for bringing the food items to an undercooled state.

In an embodiment of the present invention the apparatus is used for tumbling the food items during the advancement form the in-feed end to the out-feed end to increase tenderness of the food items.

In an embodiment of the present invention the apparatus is connected to a heat exchanger to continuously feed liquid of a desired temperature through the container.

### DESCRIPTION OF DRAWINGS

The present invention will become more fully understood from the detailed description given hereinafter and the accompanying drawings which are given by way of illustration only, and thus, are not limitative of the present invention, and wherein:

FIG. 1 is a schematic side view drawing of devices and a system according to one embodiment of the present invention.

FIG. 2 is a schematic front view drawing of devices and a system according to one embodiment of the present invention.

FIG. 3 is a perspective view of the blade according to the present invention.

FIG. 4 is a perspective view showing the features of the new screw blade.

FIG. 5 is a schematic drawing showing both a front view and a side view of the blade in different positions of a 360° rotation.

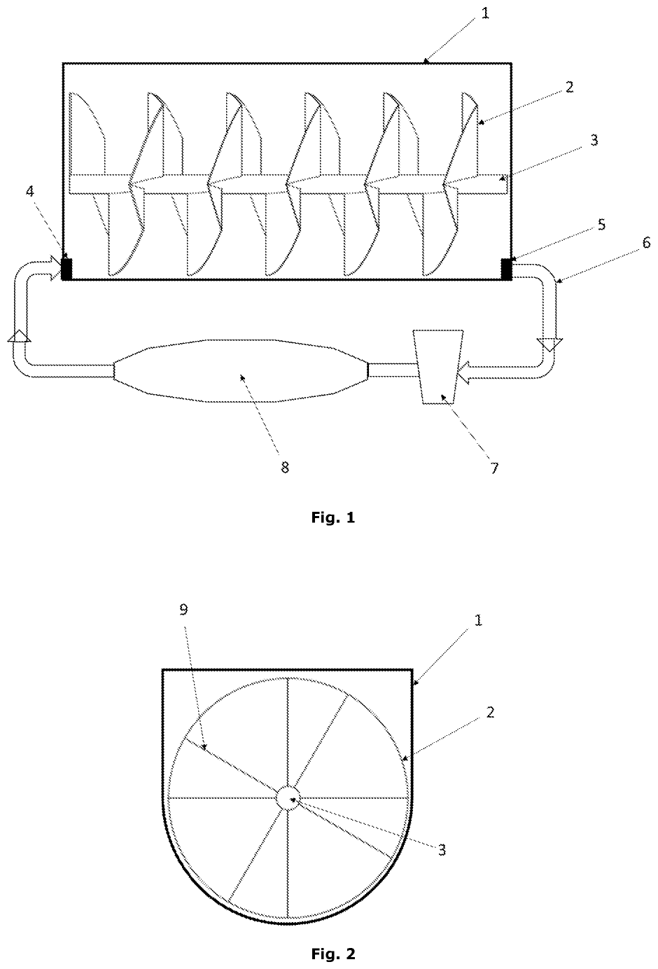

FIG. 1 shows the apparatus of the present invention. The figure is a drawing showing side view and looking through the side panel of the tank. The device is designed for transferring and treating food items in liquid where the blade advances a certain amount of food in liquid in each pitch. The device shown in FIG. 1 comprises a container 1 and a spiral shaped blade 2 mounted to a rotation axis 3 for advancing the food items from one end of the container to the other. The container has one or more fluid inlets and one or more fluid outlets for feeding liquid in and out of the container, but the apparatus shown in FIG. 1 has one fluid inlet 4 at the in-feeding end and one fluid outlet 5 at the out-feeding end. In some embodiments the fluid inlets and outlets can be positioned under each or every second pitch of the blade. The container is connected to a heat exchange element for continuously passing temperature controlled liquid through the container via the fluid inlets and outlets in the container. A tubing 6 transfers the liquid from the fluid outlet 5 to a filtering device 7 to filter the liquid before it is passed through the heat exchanger 8. After the heat exchange element has adjusted the temperature of the liquid to a desired temperature, the liquid is pumped back into the container through the fluid inlet 4.

In FIG. 2 a front view of the container is shown looking through the end panel of the tank. The drawing shows the cylindrical bottom portion of the container where the spiral shaped blade 2, rotating around an axis 3, has a diameter corresponding to the inner circumference of the container 1. The drawing also shows bends 9 in the blade, which defines one of the novel features of the present invention.

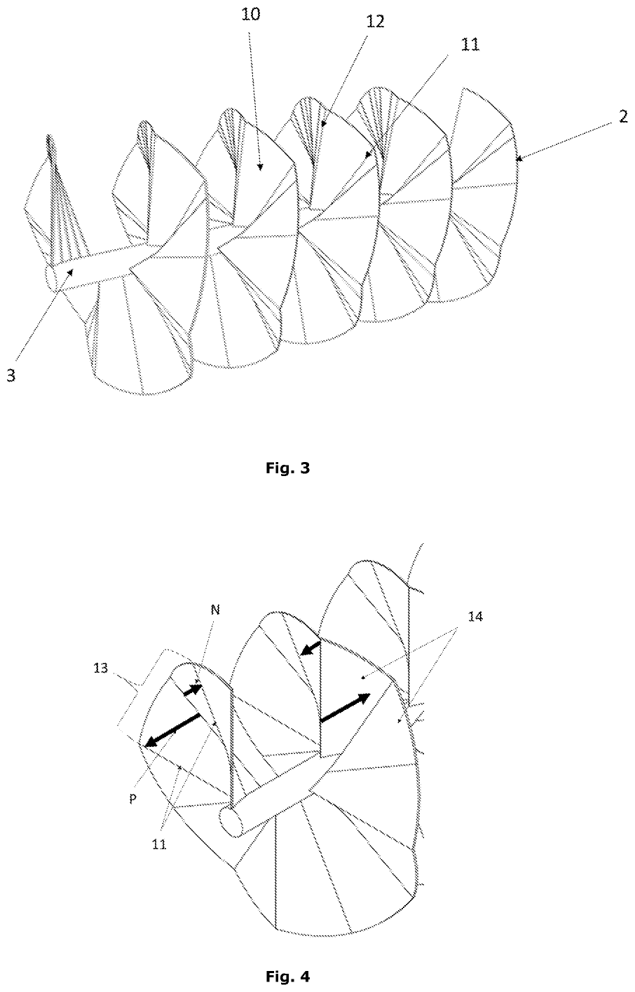

FIG. 3 shows screw blade for advancing food items in the container according to the present invention. The blade is a spiral shaped blade 2 which is mounted on and operated by a rotation axis 3 along the length of the container. The novel blade of the present invention is divided into sectors 10 by alternating positive (forward) 11 and negative (backward) 12 radial bends along the length of the spiral blade alternately changing the angle of the spiral blade along each sector 10.

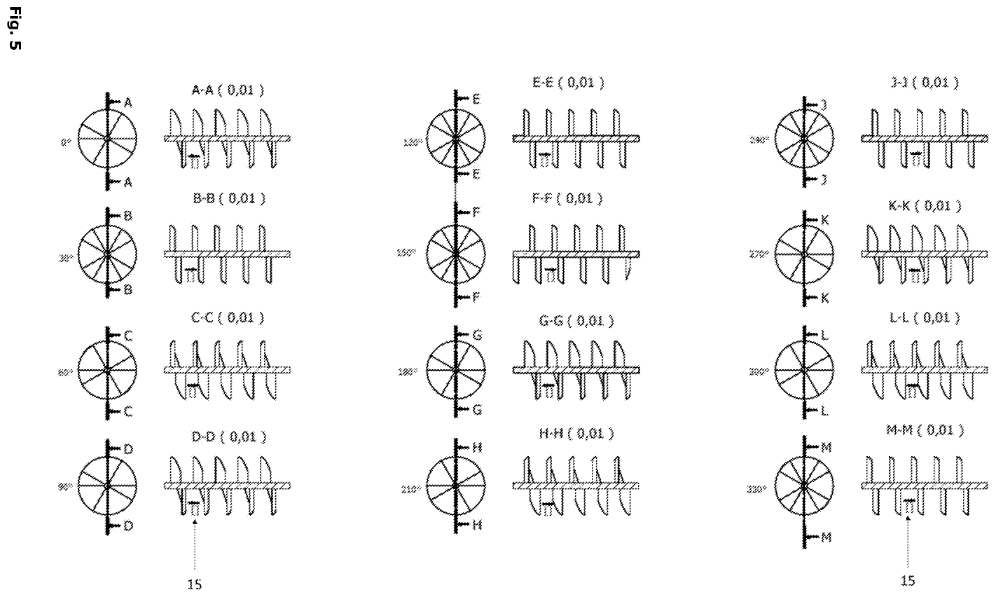

FIG. 4 shows a part of the blade of the invention defining the shape of the blade. The drawing shows a functional unit 13 between two positive radial bends 11, where each functional unit has two sectors 14 of which one is directed in the negative advancing direction (N) of the blade, thereby creating a backwards push of the material resting against that sector and the other sector is directed in the positive advancing direction (P) of the blade and thereby creating a forward advancement of the material resting against that sector.

FIG. 5 shows a front view and a side view of the blade of the invention in different positions of a 360° rotation of the blade explaining the different shape of the blade in the bottom (pushing) position. The drawing shows the blade at the following degrees: 0° (A), 30° (B), 60° (C), 90° (D), 120° (E), 150° (F), 1800° (G), 210° (H), 240° (J), 2700° (K), 3000° (L) AND, 330° (M). An item 15 is shown in the first bottom pitch in FIGS. 4A-H, but in FIG. 4J-M the item 15 has advanced along the container and is now in the second bottom pitch from the in-feed end.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

It will be appreciated that variations to the foregoing embodiments of the invention can be made while still falling within the scope of the invention can be made while still falling within scope of the invention. Features disclosed in the specification, unless stated otherwise, can be replaced by alternative features serving the same, equivalent or similar purpose. Thus, unless stated otherwise, each feature disclosed represents one example of a generic series of equivalent or similar features.

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

1. An apparatus for transferring and treating food items in liquid, said apparatus comprising:
a container
a spiral shaped blade mounted to a rotation axis for advancing the food items from one end of the container to the other,
one or more fluid inlets and one or more fluid outlets for feeding liquid in and out of the container,
wherein the spiral blade has alternating positive and negative radial bends along the length of the spiral blade.

2. The apparatus according to claim 1, wherein the alternating positive and negative radial bends along the length of the spiral blade divide the blade into sectors.

3. The apparatus according to claim 2, wherein the sector behind a positive bend is of the same size or of a different size as the sector behind negative bend.

4. The apparatus according to claim 2, wherein the size of a sector is defined as part of 20 a 360° circle of the spiral shaped blade.

5. The apparatus according to claim 2, wherein the sector behind a positive bend is directed in the negative advancing direction of the blade and wherein sector behind negative bend is directed in the positive advancing direction of the blade.

6. The apparatus according to claim 1, wherein the container is an elongated tank with a cylindrical or semi-cylindrical bottom portion, where the spiral shaped blade has a diameter corresponding to the inner circumference of the container.

7. The apparatus according to claim 1, wherein the spiral shaped blade further comprises openings for the liquid to pass through.

8. The apparatus according to claim 1, wherein the tank is connected to a heat exchange element for continuously passing temperature controlled liquid through the 35 container via the fluid inlets and outlets in the container.

9. The apparatus according to claim 1, wherein the degree of the forward and backward bend in the blade can vary.

10. The apparatus according to claim 2, wherein the size of the sectors between each forward and backward bend in the blade can vary.

11. A method for transferring and treating food items in liquid, said method using the apparatus of claim 1.

12. A method for transferring and treating food items in liquid, the method comprising the steps of:
transferring the food items to a container with a spiral shaped blade mounted to a rotation axis for advancing the food items from one end of the container to the other, said container further comprising one or more fluid inlets and one or more fluid outlets for feeding liquid in and out of the container,
advancing the food items from the in-feed end to the out-feed end of the container,
transferring the items out of the container
wherein the spiral blade has alternating positive (forward) and negative (backward) radial bends along the length of the spiral blade, thereby alternately changing the direction of the spiral blade with respect to its advancing direction, such that the food items are pushed backwards and forwards depending on the direction of the blade.

13. The method according to claim 12, wherein the alternating positive and negative radial bends along the length of the spiral thereby alternately changing the direction of the spiral blade with respect to its advancing direction, divide the blade into sectors, where the sector behind appositive bend is of the same size or of a different size as the sector behind negative bend, and wherein the size of the alternately changing sectors determines the treatment of the food items.

14. The method according to claim 13, wherein the sector behind a positive bend is directed in the negative advancing direction of the blade and thereby creating a backwards push of the material resting against that sector, and wherein sector behind negative bend is directed in the positive advancing direction of the blade and thereby creating a forward push of the material resting against that sector.

15. The method according to claim 12, wherein the apparatus is used for thawing up food items.

16. The method according to claim 12, wherein the apparatus is used for bringing the food items to an undercooled state.

17. The method according to claim 12, wherein the apparatus is used for tumbling the food items during the advancement form the in-feed end to the out-feed end to increase tenderness of the food items.

18. The method according to claim 12, wherein the apparatus is connected to a heat exchanger to continuously feed liquid of a desired temperature through the container.

19. The method according to claim 12, wherein the speed of rotation of the spiral shaped blade can vary in one 360° rotation of the blade depending on the position of the direction of the sectors of the blade in the container.
